(19) United States
(12) Patent Application Publication
(10) Pub. No.: US 2008/0306238 A1
(43) Pub. Date: Dec. 11, 2008

(54) WATER- AND OIL-REPELLENCY IMPARTING ESTER OLIGOMERS COMPRISING PERFLUOROALKYL MOIETIES

(75) Inventors: Chetan P. Jariwala, Woodbury, MN (US); Cheryl L.S. Elsbernd, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/134,434

(22) Filed: Jun. 6, 2008

Related U.S. Application Data
(60) Provisional application No. 60/942,701, filed on Jun. 8, 2007.

(51) Int. Cl. C09D 5/00; C08G 63/682; C09D 185/00

(52) U.S. Cl. 528/271; 528/401

(57) ABSTRACT

Fluorochemical ester compositions comprising one or more compounds or oligomers having at least one long chain fluorine-containing repeatable unit and at least one fluorine-containing terminal group are described. The compositions are useful as coatings. The fluorochemical compositions impart oil and water repellency to the substrate. In other aspects, this invention relates to processes for imparting oil and water repellency characteristics to substrates and articles.

### PRIORITY CLAIM

This application claims the benefit of U.S. Provisional Application No. 60/942,701, filed Jun. 8, 2007.

### FIELD OF THE INVENTION

This invention relates to fluorochemical compositions comprising one or more compounds or oligomers having at least one fluorine-containing repeatable unit and at least one fluorine-containing terminal group. This invention also relates to articles comprising a substrate and the fluorochemical composition, which may be applied as a coating. These fluorochemical compositions impart oil and water repellency to the substrate. In other aspects, this invention relates to processes for imparting oil and water repellency characteristics to substrates and articles.

### BACKGROUND OF THE INVENTION

The use of certain fluorochemical compositions on fibers and fibrous substrates, such as textiles, paper, and leather, to impart oil- and water-repellency and soil- and stain-resistance is well known in the art. See, for example, Banks, Ed., Organofluorine Chemicals and Their Industrial Applications, Ellis Horwood Ltd., Chichester, England, 1979, pp. 226-234. Such fluorochemical compositions include, for example, fluorochemical guanidines (U.S. Pat. No. 4,540,497 (Chang et al.)), compositions of cationic and non-cationic fluorochemicals (U.S. Pat. No. 4,566,981 (Howells)), compositions containing fluorochemical carboxylic acid and epoxidic cationic resin (U.S. Pat. No. 4,426,466 (Schwartz)), fluoroaliphatic carbodiimides (U.S. Pat. No. 4,215,205 (Landucci)), fluoroaliphatic alcohols (U.S. Pat. No. 4,468,527 (Patel)), fluorine-containing addition polymers, copolymers, and macromers (U.S. Pat. Nos. 2,803,615; 3,068,187; 3,102,103; 3,341,497; 3,574,791; 3,916,053; 4,529,658; 5,216,097; 5,276,175; 5,725,789; and 6,037,429), fluorine-containing phosphate esters (U.S. Pat. Nos. 3,094,547; 5,414,102; and 5,424,474), fluorine-containing urethanes (U.S. Pat. Nos. 3,987,182; 3,987,227; 4,504,401; and 4,958,039), fluorochemical allophanates (U.S. Pat. Nos. 4,606,737) fluorochemical biurets (U.S. Pat. No. 4,668,406), fluorochemical oxazolidinones (U.S. Pat. No. 5,025,052), and fluorochemical piperazines (U.S. Pat. No. 5,451,622).

A need exists for repellent treatments that provide improved ease of use and improved performance under desired conditions.

### SUMMARY OF THE INVENTION

In one aspect, this invention relates to chemical compositions comprising one or more oligomers having at least one fluorine-containing repeatable unit and at least one fluorine-containing terminal group. These oligomers comprise the condensation reaction product of:
(a) one or more polyols;
(b) one or more polyacyl compounds (such as carboxylic acids, esters, acyl halides) containing 17 or more carbon atoms; and
(c) one or more monofunctional fluorine-containing compounds comprising a functional group that is reactive with the hydroxyl group of the polyol (a) or with the acyl group of the polyacyl compound (b);
   wherein at least a portion of the polyol compounds further comprise at least one fluorine-containing group selected from the group consisting of perfluoroalkyl, perfluoroheteroalkyl, and perfluoroheteroalkylene. In some embodiments, the compounds or oligomers comprise the condensation reaction product of (a), (b), and (c) as described above and (d) one or more monofunctional non-fluorine-containing compounds. Oligomers of the invention have been surprisingly found to provide superior performance as compared to previously known shorter chain materials, particularly dynamic water repellency performance.

As used herein, the term “oligomer” means a molecule comprising at least 2 or more, up to a few, i.e., up to an average of 10, but preferably up to an average of 5, repeating (polymerized) or repeatable units. Each repeating unit comprises an ester group that is derived or derivable from the reaction of at least one polyol having an average of greater than one, preferably two or more hydroxyl moieties; and at least one polyacyl compound having an average of greater than one, preferably two or more acyl moieties, wherein at least a portion of the polyol compounds further comprises at least one fluorine-containing moiety, selected from the group consisting of perfluoroalkyl, perfluoroalkylene, perfluoroheteroalkyl, and perfluoroheteroalkylene. The oligomer is terminated with one or more perfluoroalkyl groups, one or more perfluoroheteroalkyl groups, or mixtures thereof.

Certain preferred embodiments of the fluorochemical compositions of the present invention include those compositions comprising terminal and pendant R^{f} groups having from 1 to 12 carbons, preferably 6 or fewer carbons, and more preferably 3 to 5 carbons.

Another embodiment of the present invention relates to a coating composition comprising the fluorochemical oligomer of the present invention and a solvent. In this embodiment, the fluorochemical composition is dissolved or dispersed in the solvent. When applied to a substrate, this coating composition (which might be a solution or emulsion) provides a uniform distribution of the chemical composition on the substrate without altering the appearance of the substrate. This invention further relates to a method for imparting water- and oil-repellency, stain-release, or stain-resistance characteristics to a substrate, comprised of one or more surfaces, comprising the steps of:
(a) applying the coating composition of the present invention onto one or more surfaces of the substrate wherein the coating composition comprises:
   (i) at least one solvent; and
   (ii) the fluorochemical composition of the invention; and
(b) curing the coating composition.

The fluorochemical compositions of the present invention can be applied as coatings to a wide variety of substrates, for example, by topical application, to impart oil- and water-repellency, stain-release, and stain-resistant properties to the substrates. In testing substrates coated with the fluorochemical compositions of the present invention, unexpectedly high dynamic water repellency has been observed.

When applied as a coating, the chemical compositions of the present invention can provide a uniform film. Applied as a coating, the chemical compositions of the present invention do not change the appearance of the substrate to which they are applied.

### DEFINITIONS

Unless otherwise stated, the following terms used in the specification and claims have the meanings given below:

“Acyloxy” means a radical —OC(O)R where R is alkyl, alkenyl, and cycloalkyl, e.g., acetoxy, 3,3,3-trifluoroacetoxy, propionyloxy, and the like.

“Alkenyl” means an unsaturated aliphatic radical.

“Alkoxy” means a radical —OR where R is an alkyl group, e.g., methoxy, ethoxy, propoxy, butoxy, and the like.

“Alkyl” means a linear saturated monovalent hydrocarbon radical or a branched saturated monovalent hydrocarbon radical, e.g., methyl, ethyl, 1-propyl, 2-propyl, pentyl, and the like.

“Alkylene” means a linear saturated divalent hydrocarbon radical or a branched saturated divalent hydrocarbon radical, e.g., methylene, ethylene, propylene, 2-methylpropylene, pentylene, hexylene, and the like.

“Aralkylene” means an alkylene radical defined above with an aromatic group attached to the alkylene radical, e.g., benzyl, pyridylmethyl, 1-naphthylethyl, and the like.

“Cured chemical composition” means that the chemical composition is dried or solvent has evaporated from the chemical composition under elevated temperature (e.g., 50° C. or higher) until dryness, up to approximately 24 hours.

“Fibrous substrate” means materials comprised of synthetic or inorganic fibers such as wovens, knits, nonwovens, carpets, and other textiles including laminates (PTFE and/or PU); and materials comprised of natural fibers such as cotton, paper, and leather.

“Fluorocarbon monoalcohol” means a compound having one hydroxyl group and a perfluoroalkyl or a perfluoroheteroalkyl group, e.g., C₄F₉SO₂N(CH₃)CH₂CH₂OH, C₄F₉CH₂CH₂OH, C₂F₅O(C₂F₄O)₃CF₂CONHC₂H₄OH, C₃F₇O(C₃F₆O)ₙCF(CF₃)CONHC₂H₄OH, c-C₆F₁₁CH₂OH, and the like.

“Hard substrate” means any rigid material that maintains its shape, e.g., glass, ceramic, concrete, natural stone, wood, metals, plastics, and the like.

“Heteroacyloxy” has essentially the meaning given above for acyloxy except that one or more heteroatoms (i.e., oxygen, sulfur, and/or nitrogen) may be present in the R group and the total number of carbon atoms present may be up to 50, e.g., CH₃CH₂OCH₂CH₂C(O)O—, C₄H₉OCH₂CH₂OCH₂CH₂C(O)O—, CH₃O(CH₂CH₂O)ₙCH₂CH₂C(O)O—, and the like.

“Heteroalkoxy” has essentially the meaning given above for alkoxy except that one or more heteroatoms (i.e. oxygen, sulfur, and/or nitrogen) may be present in the alkyl chain and the total number of carbon atoms present may be up to 50, e.g., CH₃CH₂OCH₂CH₂O—, C₄H₉OCH₂CH₂OCH₂CH₂O—, CH₃O(CH₂CH₂O)ₙH, and the like.

“Heteroalkyl” has essentially the meaning given above for alkyl except that one or more heteroatoms (i.e., oxygen, sulfur, and/or nitrogen) may be present in the alkyl chain, these heteroatoms being separated from each other by at least one carbon, e.g., CH₃CH₂OCH₂CH₂—, CH₃CH₂OCH₂CH₂OCH(CH₃)CH₂—, C₄F₉CH₂CH₂SCH₂CH₂—, and the like.

“Heteroalkylene” has essentially the meaning given above for alkylene except that one or more heteroatoms (i.e. oxygen, sulfur, and/or nitrogen) may be present in the alkylene chain, these heteroatoms being separated from each other by at least one carbon, e.g., —CH₂OCH₂O—, —CH₂CH₂OCH₂CH₂—, —CH₂CH₂N(CH₃)CH₂CH₂—, —CH₂CH₂SCH₂CH₂—, and the like.

“Heteroaralkylene” means an aralkylene radical defined above except that catenated oxygen, sulfur, and/or nitrogen atoms may be present, e.g., phenyleneoxymethyl, phenyleneoxyethyl, benzyleneoxymethyl, and the like.

“Halo” means fluoro, chloro, bromo, or iodo, preferably fluoro and chloro.

“Perfluoroalkyl” has essentially the meaning given above for “alkyl” except that all or essentially all of the hydrogen atoms of the alkyl radical are replaced by fluorine atoms and the number of carbon atoms is from 1 to about 12, e.g., perfluoropropyl, perfluorobutyl, perfluorooctyl, and the like.

“Perfluoroalkylene” has essentially the meaning given above for “alkylene” except that all or essentially all of the hydrogen atoms of the alkylene radical are replaced by fluorine atoms, e.g., perfluoropropylene, perfluorobutylene, perfluorooctylene, and the like

“Perfluoroheteroalkyl” has essentially the meaning given above for “heteroalkyl” except that all or essentially all of the hydrogen atoms of the heteroalkyl radical are replaced by fluorine atoms and the number of carbon atoms is from 3 to about 100, e.g., CF₃CF₂OCF₂CF₂—, CF₃CF₂O(CF₂CF₂O)₃CF₂CF₂—, or C₃F₇O(CF(CF₃)CF₂O)ₘCF(CF₃)CF₂— where m is from about 10 to about 30, and the like.

“Perfluoroheteroalkylene” has essentially the meaning given above for “heteroalkylene” except that all or essentially all of the hydrogen atoms of the heteroalkylene radical are replaced by fluorine atoms, and the number of carbon atoms is from 3 to about 100, e.g., —CF₂OCF₂—, —CF₂O(CF₂O)ₙ(CF₂CF₂O)ₘCF₂—, and the like.

“Perfluorinated group” means an organic group wherein all or essentially all of the carbon bonded hydrogen atoms are replaced with fluorine atoms, e.g. perfluoroalkyl, perfluoroheteroalkyl, and the like.

“Polyacyl compound” means a compound containing two or more acyl groups, or derivative thereof, such as carboxylic acid, ester, or acyl halide, attached to a multivalent organic group, e.g. dimethyl adipate, and the like.

“Polyol” means an organic compound or polymer with an average of at least about 2 primary or secondary hydroxyl groups per molecule, e.g., ethylene glycol, propylene glycol, 1,6-hexanediol, and the like. The compound or polymer may be fluorinated, i.e., comprising fluorine-containing moieties in the backbone or attached pendantly or both.

“Porous” means capable of imbibing a liquid.

### DETAILED DESCRIPTION OF ILLUSTRATIVE EMBODIMENTS OF THE INVENTION

The fluorochemical compositions of the present invention comprise the condensation reaction product of:
(a) one or more fluorinated polyols;
(b) one or more polyacyl compounds (such as carboxylic acids, esters, acyl halides) containing 17 or more carbon atoms; and
(c) one or more monofunctional fluorine-containing compounds comprising a functional group that is reactive with the hydroxyl group of the polyol (a) or the acyl group of the polyacyl compound (b).
   The fluorinated polyol compounds further comprise at least one fluorine-containing group selected from the group consisting of perfluoroalkyl, perfluoroheteroalkyl, and perfluoroheteroalkylene. The ester oligomers may further comprise one or more non-fluorinated polyols. Optionally, the reaction mixture of fluorochemical oligomers of the invention further comprises, in addition to (a), (b), and (c), (d) one or more monofunctional non-fluorine-containing compounds to adjust such properties as resultant repellency, melting point, etc.

The oligomer comprises at least two repeatable or repeating polymerized units. Each repeatable or repeating unit comprises one or more pendant or in-chain fluorine-containing groups selected from the group consisting of perfluoroalkyl, perfluoroalkylene, perfluoroheteroalkyl, and perfluoroheteroalkylene, and an ester group that is formed from the reaction between a polyol and a polyacyl compound. The oligomer is terminated with one or more perfluoroalkyl groups, one or more perfluoroheteroalkyl groups, or optionally one or more non-fluorine containing compounds or a mixture thereof.

It will be understood that the resultant mixture of ester molecules preferably comprises ester molecules having a varying number of repeating or repeatable units, including two and more repeating units. This mixture of ester molecules comprising a varying number of repeating units allows simple blending of the above components in preparing the fluorochemical composition.

The fluorochemical composition of the present invention comprises a mixture of ester molecules arising from the reaction of at least one diacyl compound (or a derivative thereof, for example, a dicarboxylic acid halide, a dicarboxylic acid anhydride, or a dicarboxylic acid ester), at least one fluorinated polyol, and at least one fluorine-containing monoalcohol or fluorine-containing monocarboxylic acid (or derivative), with the proviso that at least a portion of the polyol compounds is comprised of a pendant or in-chain fluorine-containing group.

Thus, the fluorochemical composition can comprise a single ester oligomer having a certain number of the specified repeating or repeatable units (a number greater than or equal to one), or it can comprise a mixture of such compounds and/or oligomers of varying numbers of repeat units.

The ester compounds and oligomers may be represented by the following formula (I):

R^{f}Q[OR²]ₒ[OC(O)R¹C(O)OR²O]ₙ[C(O)R¹C(O)]ₘT (I)

wherein:

o is a number from 0 to 1 inclusive;

n is a number from 1 to 10 inclusive;

m is a number from 0 to 1 inclusive;

R^{f} is a perfluoroalkyl group having 1 to 12, preferably 6 or fewer, most preferably 3 to 5 carbon atoms, or a perfluoroheteroalkyl group having 3 to about 50 carbon atoms with all perfluorocarbon chains present having 1 to 6, preferably 1 to 4 carbon atoms;

Q is a divalent linking group;

R¹ is the same or different and is a polyvalent organic group that is a residue of a polyacyl compound, that is a straight or branched or unsaturated chain alkylene group of 15 to 20 carbon atoms, most preferably 16 carbon atoms;

R² is the same or different divalent organic group that is a residue of the polyol, at least a portion of which are substituted with or contain one or more perfluoroalkyl groups, perfluoroheteroalkyl groups, perfluoroheteroalkylene groups, or mixtures thereof wherein preferably no more than 6 carbon atoms have a fluorine atom bonded thereto; and

T is either QR^{f} as defined above or a non-fluorine containing monofunctional compound capable of reacting with a polyacyl compound or a polyol.

With respect to the above-described R^{f} groups, it is preferred that the R^{f} group have 6 or fewer carbon atoms. It is believed that the shorter-chain R^{f} groups have a reduced tendency to bioaccumulate as described in U.S. Pat. No. 5,688,884.

Suitable linking groups Q include the following structures in addition to a covalent bond. For the purposes of this list, each k is independently an integer from 0 to about 20, R^{1′} is hydrogen, phenyl, or alkyl of 1 to about 4 carbon atoms, and R^{2′} is alkyl of 1 to about 20 carbon atoms. Each structure is non-directional, i.e., —(CH₂)ₖC(O)O— is equivalent to —O(O)C(CH₂)ₖ—.

| | |
|---|---|
| —SO₂NR^{1′}(CH₂)ₖO(O)C— | —CONR^{1′}(CH₂)ₖO(O)C— |
| —(CH₂)ₖO(O)C— | —CH₂CH(OR^{2′})CH₂O(O)C— |
| —(CH₂)ₖC(O)O— | —(CH₂)ₖSC(O)— |
| —(CH₂)ₖO(CH₂)ₖO(O)C— | —(CH₂)ₖS(CH₂)ₖO(O)C— |
| —(CH₂)ₖSO₂(CH₂)ₖO(O)C— | —(CH₂)ₖS(CH₂)ₖOC(O)— |
| —(CH₂)ₖSO₂NR^{1′}(CH₂)ₖO(O)C— | —(CH₂)ₖSO₂— |
| —SO₂NR^{1′}(CH₂)ₖO— | —SO₂NR^{1′}(CH₂)ₖ— |
| —(CH₂)ₖO(CH₂)ₖC(O)O— | —(CH₂)ₖSO₂NR^{1′}(CH₂)ₖC(O)O— |
| —(CH₂)ₖSO₂(CH₂)ₖC(O)O— | —CONR^{1′}(CH₂)ₖC(O)O— |
| —(CH₂)ₖS(CH₂)ₖC(O)O— | —CH₂CH(OR^{2′})CH₂C(O)O— |
| —SO₂NR^{1′}(CH₂)ₖC(O)O— | —(CH₂)ₖO— |
| —OC(O)NR′'(CH₂)ₖ— | —(CH₂)ₖNR^{1′}— |
| —CₖH₂ₖ—OC(O)NH— | —CₖH₂ₖ—NR^{1′}C(O)NH—, and |
| —(CH₂)ₖNR^{1′}C(O)O— | |

It will be understood that mixtures of oligomers corresponding to the general formula may be represented, in addition to single compounds, and that o, m, and n may be represented by non-integral values.

Polyols, suitable for use in preparing the fluorochemical compositions of the present invention comprising a mixture of polyol molecules, include those organic polyols that have an average hydroxyl functionality of greater than 1 (preferably about 2 to about 3; most preferably, about 2, as diols are most preferred). The hydroxyl groups can be primary or secondary, with primary hydroxyl groups being preferred for their greater reactivity.

Suitable polyols include those that comprise at least one aliphatic, heteroaliphatic, alicyclic, heteroalicyclic, aromatic, heteroaromatic, or polymeric moiety. Preferred polyols are aliphatic or polymeric polyols that contain hydroxyl groups as terminal groups.

The polyols may comprise at least one fluorine-containing group selected from the group consisting of perfluoroalkyl, perfluoroheteroalkyl, and perfluoroalkylene moieties. All of the perfluorocarbon chains, comprising these perfluoro moieties, are preferably six or fewer carbon atoms. Perfluoroalkyl moieties are preferred, with perfluoroalkyl moieties having 6 or fewer carbon atoms being preferred. Perfluoroheteroalkyl moieties may have 3 to 50 carbon atoms. Perfluoroheteroalkylene groups may have from 3 to 50 carbon atoms. Perfluoroheteroalkyl and alkylene moieties are preferably perfluoropolyethers with no perfluorocarbon chain of more than 6 carbon atoms.

Mixtures of fluorinated and non-fluorinated polyols may be advantageously utilized in preparing certain of the fluorochemical compositions of the instant invention. For example, inclusion of a non-fluorinated polyol can alter the melt temperature of the fluorochemical composition, making it more effective at the processing temperatures normally used in a given application. Increased cost effectiveness is also achieved by replacing a portion of the more expensive fluorinated polyol(s) with the less expensive non-fluorinated polyol(s). The selection of the non-fluorinated polyol(s) and the amount to use is determined by the performance requirements, for example melt temperature and repellency. When non-fluorinated polyol is used, a typically useful range of ratios of non-fluorinated polyol(s) to fluorinated polyols is about 1:1 to about 1:100.

Thus, the fluorochemical ester oligomer may comprise the condensation reaction products of one or more fluorinated polyols, optionally one or more non-fluorinated polyols, one or more polyacyl compounds and one or more monofunctional fluorine-containing compounds and optionally a non-fluorine containing monofunctional compound capable of reacting with a polyacyl compound or a polyol.

Representative examples of suitable fluorinated polyols comprised of at least one fluorine-containing group include R^{f}SO₂N(CH₂CH₂OH)₂ such as N-bis(2-hydroxyethyl)perfluorobutylsulfonamide; R^{f}OC₆H₄SO₂N(CH₂CH₂OH)₂; R^{f}SO₂N(R′)CH₂CH(OH)CH₂OH such as C₆F₁₃SO₂N(C₃H₇)CH₂CH(OH)CH₂OH; R^{f}CH₂CON(CH₂CH₂OH)₂; R^{f}CON(CH₂CH₂OH)₂; CF₃CF₂(OCF₂CF₂)₃OCF₂CON(CH₃)CH₂CH(OH)CH₂OH; R^{f}OCH₂CH(OH)CH₂OH such as C₄F₉OCH₂CH(OH)CH₂OH; R^{f}CH₂CH₂SC₃H₆OCH₂CH(OH)CH₂OH; R^{f}CH₂CH₂SC₃H₆CH(CH₂OH)₂; R^{f}CH₂CH₂SCH₂CH(OH)CH₂OH; R^{f}CH₂CH₂SCH(CH₂OH)CH₂CH₂OH; R^{f}CH₂CH₂CH₂SCH₂CH(OH)CH₂OH such as C₅F₁₁(CH₂)₃SCH₂CH(OH)CH₂OH; R^{f}CH₂CH₂CH₂OCH₂CH(OH)CH₂OH such as C₅F₁₁(CH₂)₃OCH₂CH(OH)CH₂OH; R^{f}CH₂CH₂CH₂OC₂H₄OCH₂CH(OH)CH₂OH; R^{f}CH₂CH₂(CH₃)OCH₂CH(OH)CH₂OH; R^{f}(CH₂)₄SC₃H₆CH(CH₂OH)CH₂OH; R^{f}(CH₂)₄SCH₂CH(CH₂OH)₂; R^{f}(CH₂)₄SC₃H₆OCH₂CH(OH)CH₂OH; R^{f}CH₂CH(C₄H₉)SCH₂CH(OH)CH₂OH; R^{f}CH₂OCH₂CH(OH)CH₂OH; R^{f}CH2CH(OH)CH₂SCH₂CH₂OH; R^{f}CH₂CH(OH)CH₂SCH₂CH₂OH; R^{f}CH₂CH(OH)CH₂OCH₂CH₂OH; R^{f}CH₂CH(OH)CH₂OH; R^{f}R″SCH(R′″OH)CH(R′″OH)SR″R^{f}; (R^{f}CH₂CH₂SCH₂CH₂SCH₂)₂C(CH₂OH)₂; ((CF₃)₂CFO(CF₂)₂(CH₂)₂SCH₂)₂C(CH₂OH)₂; (R^{f}R″SCH₂)₂C(CH₂OH)₂; 1,4-bis(1-hydroxy-1,1-dihydroperfluoroethoxyethoxy)perfluoro-n-butane (HOCH₂CF₂OC₂F₄O(CF₂)₄OC₂F₄OCF₂CH₂OH); 1,4-bis(1-hydroxy-1,1-dihydroperfluoropropoxy)perfluoro-n-butane (HOCH₂CF₂CF₂O(CF₂)₄OCF₂CF₂CH₂OH); fluorinated oxetane polyols made by the ring-opening polymerization of fluorinated oxetane such as POLY-3-FOX™ (from Omnova Solutions, Inc., Akron, Ohio); polyetheralcohols prepared by ring opening addition polymerization of a fluorinated organic group substituted epoxide with a compound containing at least two hydroxyl groups as described in U.S. Pat. No. 4,508,916 (Newell et al.); and perfluoropolyether diols such as FOMBLIN™ ZDOL (HOCH₂CF₂O(CF₂O)₈₋₁₂(CF₂CF₂O)₈₋₁₂CF₂CH₂OH from Ausimont); wherein

R^{f} is a perfluoroalkyl group having 1 to 6 carbon atoms, or a perfluoroheteroalkyl group having 3 to about 50 carbon atoms with all perfluorocarbon chains present having 6 or fewer carbon atoms, or mixtures thereof;

R′ is alkyl of 1 to 4 carbon atoms; R″ is branched or straight chain alkylene of 1 to 12 carbon atoms, alkylenethio-alkylene of 2 to 12 carbon atoms, alkylene-oxyalkylene of 2 to 12 carbon atoms, or alkylene iminoalkylene of 2 to 12 carbon atoms, where the nitrogen atom contains as a third substituent hydrogen or alkyl of 1 to 6 carbon atoms; and

R′″ is a straight or branched chain alkylene of 1 to 12 carbon atoms or an alkylene-polyoxyalkylene of formula CᵣH₂ᵣ(OC_{S}H₂ₛ)ₜ where r is 1 to 12, s is 2 to 6, and t is 1 to 40.

Preferred polyols comprised of at least one fluorine-containing group include N-bis(2-hydroxyethyl)perfluorobutylsulfonamide; fluorinated oxetane polyols made by the ring-opening polymerization of fluorinated oxetane such as POLY-3-FOX™ (from Omnova Solutions, Inc., Akron Ohio); polyetheralcohols prepared by ring opening addition polymerization of a fluorinated organic group substituted epoxide with a compound containing at least two hydroxyl groups as described in U.S. Pat. No. 4,508,916 (Newell et al.); perfluoropolyether diols such as FOMBLIN™ ZDOL (HOCH₂CF₂O(CF₂O)₈₋₁₂(CF₂CF₂O)₈₋₁₂CF₂CH₂OH from Ausimont); 1,4-bis(1-hydroxy-1,1-dihydroperfluoroethoxyethoxy)perfluoro-n-butane (HOCH₂CF₂OC₂F₄O(CF₂)₄OC₂F₄OCF₂CH₂OH); and 1,4-bis(1-hydroxy-1,1-dihydroperfluoropropoxy)perfluoro-n-butane (HOCH₂CF₂CF₂O(CF₂)₄OCF₂CF₂CH₂OH).

More preferred polyols comprised of at least one fluorine-containing group include N-bis(2-hydroxyethyl)perfluorobutylsulfonamide; 1,4-bis(1-hydroxy-1,1-dihydroperfluoropropoxy)perfluoro-n-butane (HOCH₂CF₂CF₂O(CF₂)₄OCF₂CF₂CH₂OH).

Representative examples of suitable non-polymeric, non-fluorinated polyols include alkylene glycols, polyhydroxyalkanes, and other polyhydroxy compounds. The alkylene glycols include, for example, 1,2-ethanediol; 1,2-propanediol; 3-chloro-1,2-propanediol; 1,3-propanediol; 1,3-butanediol; 1,4-butanediol; 2-methyl-1,3-propanediol; 2,2-dimethyl-1,3-propanediol (neopentylglycol); 2-ethyl-1,3-propanediol; 2,2-diethyl-1,3-propanediol; 1,5-pentanediol; 2-ethyl-1,3-pentanediol; 2,2,4-trimethyl-1,3-pentanediol; 3-methyl-1,5-pentanediol; 1,2-, 1,5-, and 1,6-hexanediol; 2-ethyl-1,6-hexanediol; bis(hydroxymethyl)cyclohexane; 1,8-octanediol; bicyclo-octanediol; 1,10-decanediol; tricyclo-decanediol; norbornanediol; and 1,18-dihydroxyoctadecane. The polyhydroxyalkanes include, for example, glycerine; trimethylolethane; trimethylolpropane; 2-ethyl-2-(hydroxymethyl)-1,3-propanediol; 1,2,6-hexanetriol; pentaerythritol; quinitol; mannitol; and sorbitol. The other polyhydroxy compounds include, for example, polyols such as di(ethylene glycol); tri(ethylene glycol); tetra(ethylene glycol); tetramethylene glycol; dipropylene glycol; diisopropylene glycol; tripropylene glycol; bis(hydroxymethyl)propionic acid; N,N-bis(2-hydroxyethyl)-3-aminopropyltriethoxysilane; bicine; 1,11-(3,6-dioxaundecane)diol; 1,14-(3,6,9,12-tetraoxatetradecane)diol; 1,8-(3,6-dioxa-2,5,8-trimethyloctane)diol; 1,14-(5,10-dioxatetradecane)diol; castor oil; 2-butyne-1,4-diol; N,N-bis(hydroxyethyl)benzamide; 4,4′-bis(hydroxymethyl)diphenylsulfone; 1,4-benzenedimethanol; 1,3-bis(2-hydroxyethyoxy)benzene; 1,2-dihydroxybenzene; resorcinol; 1,4-dihydroxybenzene; 3,5-, 2,6-, 2,5-, and 2,4-dihydroxybenzoic acid; 1,6-, 2,6-, 2,5-, and 2,7-dihydroxynaphthalene; 2,2′- and 4,4′-biphenol; 1,8-dihydroxybiphenyl; 2,4-dihydroxy-6-methyl-pyrimidine; 4,6-dihydroxypyrimidine; 3,6-dihydroxypyridazine; bisphenol A; 4,4′-ethylidenebisphenol; 4,4′-isopropylidenebis(2,6-dimethylphenol); bis(4-hydroxyphenyl)methane; 1,1-bis(4-hydroxyphenyl)-1-phenylethane (bisphenol C); 1,4-bis(2-hydroxyethyl)piperazine; bis(4-hydroxyphenyl)ether; as well as other aliphatic, heteroaliphatic, saturated alicyclic, aromatic, saturated heteroalicyclic, and heteroaromatic polyols; and the like, and mixtures thereof.

Representative examples of useful polymeric non-fluorinated polyols include polyoxyethylene, polyoxypropylene, and ethylene oxide-terminated polypropylene glycols and triols of molecular weights from about 200 to about 2000, corresponding to equivalent weights of about 100 to about 1000 for the diols or about 70 to about 700 for triols; polytetramethylene glycols of varying molecular weight; polydialkylsiloxane diols of varying molecular weight; hydroxy-terminated polyesters and hydroxy-terminated polylactones (e.g., polycaprolactone polyols); hydroxy-terminated polyalkadienes (e.g., hydroxyl-terminated polybutadienes); and the like. Mixtures of polymeric polyols can be used if desired.

Useful commercially available polymeric non-fluorinated polyols include CARBOWAX™ poly(ethylene glycol) materials in the number average molecular weight (Mₙ) range of from about 200 to about 2000 (from Union Carbide Corp.); poly(propylene glycol) materials such as PPG-425 (from Lyondell Chemicals); block copolymers of poly(ethylene glycol) and poly(propylene glycol) such as PLURONIC™ L31 (from BASF Corporation); Bisphenol A ethoxylate, Bisphenol A propyloxylate, and Bisphenol A propoxylate/ethoxylate (from Sigma-Aldrich); polytetramethylene ether glycols such as POLYMEG™ 650 and 1000 (from Quaker Oats Company) and the TERATHANE™ polyols (from DuPont); hydroxyl-terminated polybutadiene resins such as the Poly Bd™ materials (from Elf Atochem); the “PeP” series (from Wyandotte Chemicals Corporation) of polyoxyalkylene tetrols having secondary hydroxyl groups, for example, “PeP” 450, 550, and 650; polycaprolactone polyols with Mₙ in the range of about 200 to about 2000 such as TONE™ 0201, 0210, 0301, and 0310 (from Union Carbide); PARAPLEX™ U-148 (from Rohm and Haas), an aliphatic polyester diol; polyester polyols such as the MULTRON™ poly(ethyleneadipate)polyols (from Mobay Chemical Co.); polycarbonate diols such as DURACARB™ 120, a hexanediol carbonate with Mₙ=900 (from PPG Industries Inc.); and the like; and mixtures thereof.

Preferred non-fluorinated polyols include 1,2-ethanediol; 1,2- and 1,3-propanediol; 1,3- and 1,4-butanediol; neopentylglycol; 1,5-pentanediol; 3-methyl-1,5-pentanediol; 1,2-, 1,5-, and 1,6-hexanediol; bis(hydroxymethyl)cyclohexane; 1,8-octanediol; 1,10-decanediol; di(ethylene glycol); tri(ethylene glycol); tetra(ethylene glycol); di(propylene glycol); di(isopropylene glycol); tri(propylene glycol); poly(ethylene glycol) diols (number average molecular weight of about 200 to about 1500); poly(di(ethylene glycol) phthalate) diol (having number average molecular weights of, for example, about 350 or about 575); poly(propylene glycols) diols (number average molecular weight of about 200 to about 500); block copolymers of poly(ethylene glycol) and poly(propylene glycol) such as PLURONIC™ L31 (from BASF Corporation); polycaprolactone diols (number average molecular weight of about 200 to about 600); resorcinol; hydroquinone; 1,6-, 2,5-, 2,6-, and 2,7-dihydroxynaphthalene; 4,4′-biphenol; bisphenol A; bis(4-hydroxyphenyl)methane; and the like; and mixtures thereof.

More preferred non-fluorinated polyols include 1,2-ethanediol; 1,2- and 1,3-propanediol; 1,4-butanediol; neopentylglycol; 1,2- and 1,6-hexanediol; di(ethylene glycol); tri(ethylene glycol); poly(di(ethylene glycol) phthalate) diol (having number average molecular weights of, for example, about 350 or about 575); poly(ethylene glycol) diols (having number average molecular weights of, for example, about 200, 300, 400); polypropylene glycol (having a number average molecular weight of, for example, about 425); dimer diol; polycaprolactone diol (having a number average molecular weight of, for example, about 530); 3,5-dihydroxybenzene; bisphenol A; resorcinol; hydroquinone; and mixtures thereof.

Polyacyl compounds and derivatives thereof (for example, dicarboxylic acid halides, dicarboxylic acid anhydrides, and dicarboxylic acid esters) suitable for use in preparing the fluorochemical composition comprise at least one aliphatic, heteroaliphatic (that is, containing in-chain heteroatoms, such as nitrogen, oxygen, or sulfur), saturated alicyclic, saturated heteroalicyclic, or polymeric moiety. Preferably, the polyacyl compounds are aliphatic in nature.

Acyl derivatives are sometimes preferred over acids for a variety of reasons. For example, acyl halides provide both relatively fast reaction rates and reactions that tend to go to completion. The resulting HCl is volatile and can be removed under vacuum or by other removal means, such as by water washing.

When a polyacid is used, a catalyst such as p-toluenesulfonic acid or trifluoromethanesulfonic acid can be used and can be selected so as to be removable or deactivatable (e.g., reacted with a base such as triethylamine, CaO, etc.) after reaction is complete so as to cause minimal decomposition of the resulting fluorochemical composition under use conditions.

Representative examples of suitable dicarboxylic acids and dicarboxylic acid derivatives include the following acids and their corresponding esters, halides, and anhydrides: octadecanedioic acid (i.e., R¹ is 16), eicosanedioic acid (i.e., R¹ is 18), and docosanedioic acid (i.e., R¹ is 20), most preferably 16 carbon atoms.

When fluorochemical compositions of the present invention are used as topical treatments, aliphatic dicarboxylic acids (and derivatives thereof) are preferred.

Fluorochemical monofunctional compounds, useful in preparing the fluorochemical compositions of the present invention comprising a mixture of ester molecules, include those that comprise at least one R^{f} group. The R^{f} groups can contain straight chain, branched chain, or cyclic fluorinated alkylene groups or any combination thereof. The R^{f} groups can optionally contain one or more heteroatoms (i.e., oxygen, sulfur, and/or nitrogen) in the carbon-carbon chain so as to form a carbon-heteroatom-carbon chain (i.e., a heteroalkylene group). Fully-fluorinated groups are generally preferred, but hydrogen or chlorine atoms can also be present as substituents, provided that no more than one atom of either is present for every two carbon atoms. It is additionally preferred that any R^{f} group contain at least about 40% fluorine by weight, more preferably at least about 50% fluorine by weight. The terminal portion of the group is generally fully-fluorinated, preferably containing at least three fluorine atoms, e.g., CF₃O—, CF₃CF₂—, CF₃CF₂CF₂—, (CF₃)₂N—, (CF₃)₂CF—, SF₅CF₂—. Perfluorinated aliphatic groups (i.e., those of the formula CₙF₂ₙ₊₁—) wherein n is 1 to 6 inclusive are preferred. Further, it is preferred that the fluorochemical monofunctional compounds have a melting point above room temperature. It has been found that the oligomers derived from room temperature solid or crystallizable fluorochemical monofunctional compounds exhibit higher contact angle performance than lower melting compounds.

Useful fluorine-containing monofunctional compounds also include compounds of the following formula II:

R^{f}Q′ (II)

wherein:

R^{f} is a perfluoroalkyl group having 1 to 12 carbon atoms, or a perfluoroheteroalkyl group having 3 to about 50 carbon atoms with all perfluorocarbon chains present having 6 or fewer carbon atoms;

Q′ is a moiety comprising a functional group that is reactive toward the terminal acyl (of the polyacyl compound) or hydroxyl groups (of the polyol).

It will be understood with reference to Formula I that the compound R^{f}Q′ reacts with the polyol or acyl compounds to provide the terminal moiety R^{f}Q-.

R^{f}Q′ may comprise fluorine-containing monoalcohols including the following:

| | |
|---|---|
| R^{f}SO₂N(CH₃)CH₂CH₂OH, | CF₃(CF₂)₃SO₂N(CH₃)CH₂CH₂OH, |
| CF₃(CF₂)₃SO₂N(CH₃)CH(CH₃)CH₂OH, | CF₃(CF₂)₃SO₂N(CH₃)CH₂CH(CH₃)OH, |
| | R^{f}SO₂N(H)(CH₂)₂OH, |
| R^{f}SO₂N(CH₃)(CH₂)₄OH, | C₄F₉SO₂N(CH₃)(CH₂)₄OH |
| C₆F₁₃SO₂N(CH₃)(CH₂)₄OH, | R^{f}SO₂N(CH₃)(CH₂)₁₁OH, |
| R_{f}SO₂N(C₂H₅)CH₂CH₂OH, | CF₃(CF₂)₃SO₂N(C₂H₅)CH₂CH₂OH, |
| C₆F₁₃SO₂N(C₂H₅)CH₂CH₂OH | R^{f}SO₂N(C₂H₅)(CH₂)₆OH |
| R^{f}SO₂N(C₂H₅)(CH₂)₁₁OH | R^{f}SO₂N(C₃H₇)CH₂OCH₂CH₂CH₂OH |
| R^{f}SO₂N(CH₂CH₂CH₃)CH₂CH₂OH, | R^{f}SO₂N(C₄H₉)(CH₂)₄OH |
| R^{f}SO₂N(C₄H₉)CH₂CH₂OH | C₃F₇CONHCH₂CH₂OH |

2-(N-methyl-2-(4-perfluoro-(2,6-diethylmorpholinyl))perfluoroethylsulfonamido)ethanol

| | |
|---|---|
| R^{f}CON(CH₃)CH₂CH₂OH | R^{f}CON(C₂H₅)CH₂CH₂OH |
| R^{f}CON(CH₃)(CH₂)₁₁OH | R^{f}CON(H)CH₂CH₂OH |
| C₂F₅O(C₂F₄O)₃CF₂CONHC₂H₄OH | CF₃O(CF(CF₃)CF₂O)₁₋₃₆CF(CF₃)CH₂OH |
| C₂F₅O(CF(CF₃)CF₂O)₁₋₃₆CF(CF₃)CH₂OH | C₃F₇O(CF(CF₃)CF₂O)₁₋₃₆CF(CF₃)CH₂OH |
| C₄F₉O(CF(CF₃)CF₂O)₁₋₃₆CF(CF₃)CH₂OH | C₃F₇O(CF(CF₃)CF₂O)₁₂CF(CF₃)CH₂OH |
| CF₃O(CF₂CF₂O)₁₋₃₆CF₂CH₂OH, | C₂F₅O(CF₂CF₂O)₁₋₃₆CF₂CH₂OH |
| C₃F₇O(CF₂CF₂O)₁₋₃₆CF₂CH₂OH | C₄F₉O(CF₂CF₂O)₁₋₃₆CF₂CH₂OH |
| n-C₄F₉OC₂F₄OCF₂CH₂OCH₂CH₂OH | CF₃O(CF₂CF₂O)₁₁CF₂CH₂OH |
| R^{f}SO₂CH₂CH₂OH | R^{f}C(O)OCH₂CH₂CH(CH₃)OH |
| R^{f}C(O)OCH₂CH₂OH | C₅F₁₁C(O)OCH₂CH₂OH |
| R^{f}(CH₂)₁₁N(C₂H₅)CH₂CH₂OH | R^{f}CH₂OH |
| C₃F₇CH₂OH | Perfluoro(cyclohexyl)methanol |
| C₄F₉CH₂CH₂OH | CF₃(CF₂)₅CH₂CH₂OH |
| R^{f}CH₂CH₂SO₂N(CH₃)CH₂CH₂OH | CF₃(CF₂)₅CH₂CH₂SO₂N(CH₃)CH₂CH₂OH |
| CF₃(CF₂)₃CH₂CH₂SO₂N(CH₃)CH₂CH₂OH | R^{f}CH₂CH₂CH₂OH |
| R^{f}(CH₂)₂OH | R^{f}(CH₂)₂S(CH₂)₂OH |
| C₄F₉(CH₂)₂S(CH₂)₂OH | R^{f}(CH₂)₄S(CH₂)₂OH |
| R^{f}(CH₂)₂S(CH₂)₃OH | R^{f}(CH₂)₂SCH(CH₃)CH₂OH, |
| R^{f}(CH₂)₄SCH(CH₃)CH₂OH | R^{f}CH₂CH(CH₃)S(CH₂)₂OH |
| R^{f}(CH₂)₂S(CH₂)₁₁OH | R^{f}(CH₂)₂S(CH₂)₃O(CH₂)₂OH |
| R^{f}(CH₂)₃O(CH₂)₂OH | R^{f}(CH₂)₃SCH(CH₃)CH₂OH |
| R^{f}SO₂N(H)(C₂H₄)OC(O)(CH₂)₅OH | |

and the like, and mixtures thereof, wherein R^{f} is a perfluoroalkyl group having 1 to 12 carbon atoms, or a perfluoroheteroalkyl group having 3 to about 50 carbon atoms with all perfluorocarbon chains present having 6 or fewer carbon atoms. If desired, rather than using such alcohols, similar thiols can be utilized.

Preferred fluorine-containing monoalcohols include 2-(N-methylperfluorobutanesulfonamido)ethanol; 2-(N-ethylperfluorobutanesulfonamido) ethanol; 2-(N-methylperfluorobutanesulfonamido)propanol; N-methyl-N-(4-hydroxybutyl)perfluorohexanesulfonamide; 1,1,2,2-tetrahydroperfluorooctanol; 1,1-dihydroperfluorooctanol; C₆F₁₃CF(CF₃)CO₂C₂H₄CH(CH₃)OH; n-C₆F₁₃CF(CF₃)CON(H)CH₂CH₂OH; C₄F₉OC₂F₄OCF₂CH₂OCH₂CH₂OH; C₃F₇CON(H)CH₂CH₂OH; 1,1,2,2,3,3-hexahydroperfluorodecanol; C₃F₇O(CF(CF₃)CF₂O)₁₋₃₆CF(CF₃)CH₂OH; CF₃O(CF₂CF₂O)₁₋₃₆CF₂CH₂OH; C₄F₉—SO₂NMeC₂H₄OH; and the like; and mixtures thereof.

Other useful fluorine-containing compounds include functional oligomeric fluoroacrylates such as those described as component (a) in paragraph [00010] of U.S. Patent Application No. 2007/0004895 (incorporated herein by reference in its entirety) and fluorinated polyethers such as those described in formulas (I) and (III) of U.S. Pat. No. 7,214,736 (incorporated herein by reference in its entirety) where Tₖ is a reactive group capable of reacting with an acyl group or hydroxyl group.

The fluorochemical monofunctional compound, R^{f}Q′, may comprise derivatives (such as esters or acid halides) of fluorine-containing monocarboxylic acids including (1) those having the formula R^{f}(CH₂)ₙ(X)ₚ(CH₂)ₘC(O)OH, wherein R^{f} is as defined above, n and m are independently integers of 0 to 14 (preferably 0 to 8, more preferably 0 to 4), X is divalent oxygen or sulfur, and p is an integer of 0 or 1, and (2) those having the formula R^{f}QR′C(O)OH, wherein R^{f} is as defined above, R′ is a divalent alkyl (straight chain or branched) or cycloalkyl radical having from 1 to about 12 carbon atoms (preferably from 1 to about 8 carbon atoms, more preferably from 1 to about 4 carbon atoms), and the divalent linking group Q is —SO₂N(R″)— or —CON(R″)— wherein R″ is a monovalent alkyl (straight chain or branched), cycloalkyl, or aryl radical having from 1 to about 12 carbon atoms (preferably from 1 to about 8 carbon atoms, more preferably from 1 to about 4 carbon atoms).

Representative examples of useful derivatives of fluorine-containing monocarboxylic acids include perfluorobutanoic (C₃F₇C(O)OH), perfluoroisobutanoic ((CF₃)₂CFC(O)OH), hydroperfluorobutanoic (C₃F₆HC(O)OH), perfluoropentanoic (C₄F₉C(O)OH), hydroperfluoropentanoic (C₄F₈HC(O)OH), perfluorohexanoic (C₅F₁₁C(O)OH), hydroperfluorohexanoic (C₅F₁₀HC(O)OH), perfluorocyclohexanyl carboxylic (C₆F₁₁C(O)OH), perfluoroheptanoic (C₆F₁₃C(O)OH), perfluoro(3-ethoxypropionic), perfluoro(3-propoxypropionic), perfluoro(3-butoxypropionic), perfluoro(3-pentoxypropionic), R^{f}[OCF(CF₃)CF₂]₁₋₆OCF(CF₃)C(O)OH where R^{f} is a perfluoroalkyl group of 1 to 12 carbon atoms, 4-(4-perfluoroisopropoxyperfluorobutyl) butanoic, 4-(bis(perfluoroisopropyl)fluoromethoxy)perfluorobutanoic, 12-(2-perfluoroisopropoxyperfluoroethyl) dodecanoic, 6-(2-perfluorocyclobutoxyperfluoroethyl) hexanoic, 4-(bis(perfluoroisopropyl)fluoromethoxy)perfluorobutanoic, 4-(2-bis(perfluoroisopropyl)fluoromethoxyperfluoroethyl)butanoic, 2-(N-(ethyl)perfluorobutanesulfonamido)acetic, and 2-(N-(methyl)perfluorobutanesulfonamido)acetic, and the like, and mixtures thereof.

Preferred fluorine-containing monocarboxylic acids include 2-(N-(ethyl)perfluorobutanesulfonamido)acetic, 2-(N-(methyl)perfluorobutanesulfonamido) acetic, and the like, and mixtures thereof.

It will be understood, with respect to the above lists, that the terminal hydroxyl or carboxyl groups may be replaced with other functional groups Q′ that are reactive with terminal acyl group (of the polyacyl compounds) or hydroxyl groups (of the polyol) to form the linking group Q of Formula I.

If desired, non-fluorinated monofunctional compounds, such as monoalcohol(s) or monocarboxylic acid(s) can be utilized in addition to the fluorine-containing monoalcohol(s) or monocarboxylic acid(s) as a portion of the total monoalcohol or monocarboxylic acid charge (for example, in amounts up to about 50 mole percent of the total).

The most preferred ester oligomers comprises the condensation reaction product of one or more fluorinated polyols, an excess amount (relative to the polyol) of one or more diacyl compounds, and sufficient fluorinated monoalcohols to react with the terminal acyl groups. Such most preferred oligomers correspond to the Formula (III)

R^{f}Q[C(O)R³C(O)OR⁴O]ₙ[C(O)R³C(O)]ₘQR^{f} (III)

wherein:

n is a number from 1 to 10 inclusive;

m is 1;

R^{f} is a perfluoroalkyl group having 1 to 12, preferably 6 or fewer carbon atoms, or a perfluoroheteroalkyl group having 3 to about 50 carbon atoms with all perfluorocarbon chains present having 1 to 6, preferably 1 to 4 carbon atoms;

Q is a divalent linking group as previously described;

R³ which may be the same or different is a straight chain alkylene of 15 to 20 carbon atoms;

R⁴ is a polyvalent organic group which is a residue of the polyol, that is a straight or branched chain alkylene, cycloalkylene, arylene or heteroalkylene group of 1 to 14 carbon atoms, preferably 1 to 8 carbon atoms, more preferably 1 to 4 carbon atoms, and most preferably two carbon atoms, or an arylene group of 6 to 12 carbon atoms; at least a portion of R⁴ groups are substituted with or contain one perfluoroalkyl group, perfluoroheteroalkyl group, perfluoroheteroalkylene group, or mixtures thereof.

The fluorochemical compositions may further comprise the reaction product of polymerizable compounds comprising one or more polymerizable groups and at least one reactive group, reactive with hydroxyl or acyl groups. The polymerizable group may be incorporated into the fluorochemical ester oligomers by means of a reactive functional group, as previously described. Examples of useful polymerizable groups include but are not limited to acrylate, methacrylate, vinyl, allyl, and glycidyl. Representative useful compounds having polymerizable groups include hydroxyethyl acrylate, hydroxyethyl methacrylate, pentaerythriol triacrylate, allyl alcohol, glycidol, C₂H₅(CH₃)C═NOH, CH₂═CHO(CH₂)₄OH and glycidyl methacrylate.

The fluorochemical compositions of the present invention comprising a mixture of ester molecules can be made by simple blending of the polyol(s), monofunctional compound(s), polyacyl compound(s) and optionally (d) one or more polymerizable compounds. As one skilled in the art would understand, the order of blending or the ordering of the steps is non-limiting and can be modified so as to produce a desired fluorochemical composition. In the synthesis, for example, the polyacyl compound(s), the polyol(s), the fluorine-containing monofunctional compound (R_{f}Q′), and optionally (d) one or more polymerizable compounds and a solvent are charged to a dry reaction vessel in immediate succession or as pre-made mixtures. When a homogeneous mixture or solution is obtained a catalyst is typically added, and the reaction mixture is heated. The temperature is generally determined by the boiling point of the solvent, and the boiling point of the byproducts. Byproducts, such as water or alcohols are generally removed by azeotropic distillation.

When a fluorine-containing monofunctional compound (R^{f}Q′) is used to prepare fluorine-containing ester oligomers of Formula I above, the molar ratio of monofunctional compound and/or polyol to polyacyl compound can be varied to control the molecular weight and to tailor the properties of the resultant polyester as desired.

Depending on reaction conditions (e.g., reaction temperature and/or polyacyl compound used), a catalyst level of up to about 0.5 percent by weight of the polyacyl compound/polyol/monofunctional compound mixture may be used, but typically about 0.00005 to about 0.5 percent by weight is required, about 0.02 to about 0.1 percent by weight being preferred. Suitable catalysts include those acid and base esterification catalysts such as are known in the art. Useful catalysts include para-toluene sulfonic acid and CF₃SO₃H. If an acid catalyst is used, it is preferably removed from the oligomer or neutralized after the oligomerization. It has been found that the presence of the catalyst may deleteriously affect the contact angle performance.

A mixture of polyols and/or a mixture of monofunctional compounds can be used instead of a single polyol and/or a single monofunctional compound. For example, a polyol mixture comprising a polyol with a polymerizable group and a polyol with an R^{f} group can be used. As well, a monofunctional compound mixture comprising a monofunctional compound with a polymerizable group and a fluorine-containing monofunctional compound can be used.

The fluorochemical compositions of the invention can be prepared by using procedures and apparatus known to those skilled in the art of esterification and ester exchange reactions. For example, the fluorochemical compositions can be prepared by (a) simultaneously reacting the fluorine-containing monofunctional compound with the polyol and the diacyl compound (or derivative); (b) first reacting the polyol with the polyacyl compound (or derivative), and then reacting the resulting mixture with the fluorine-containing monofunctional compound; or (c) first reacting either the fluorine-containing monofunctional compound with the diacyl compound (or derivative) or the fluorine-containing monofunctional compound with the polyol, and then reacting the resulting mixture with the remaining reactant.

The reactions can be carried out in solution or in the molten state (using commonly-used solvents and/or equipment), generally under atmospheric pressure and at temperatures sufficient to maintain the reactants in solution or in the melt. For example, melt temperatures in the range of about 90 to about 240° C. (preferably, about 100 to about 210° C.; more preferably, about 110 to about 170° C.) can generally be utilized. Removal of solvent or byproduct HCl, if present, can be conducted at reduced pressures, for example, using a vacuum equivalent to about 500 torr (67 kPa) or less. Removal of esterification byproducts by distillation may be effected by selection of an appropriate solvent, such as toluene or fluorinated ethers such as NOVEC™ HFE-7100™ or HFE-7200™ (from 3M Company).

If water is a by-product, then water immiscible hydrocarbon solvents such as heptane or toluene, fluorinated ethers, or perfluorocarbons are preferred. If the byproducts are lower alcohols, then perfluorocarbons are preferred.

The fluorochemical compositions of the present invention comprising a mixture of ester oligomers can also be made following a step-wise synthesis in addition to a batch method. In the synthesis, the polyacyl compound and the polyol are dissolved together under dry conditions, preferably in a solvent, and then the resulting solution is heated as previously described, with mixing in the presence of a catalyst for one-half to two hours, preferably one hour.

The resulting ester oligomers may then be further reacted with one or more of the monofunctional compounds described above. The monofunctional compounds may be added to the above reaction mixture, and react(s) with the remaining or a substantial portion of the remaining hydroxyl or acyl groups. The above temperatures, dry conditions, and mixing are continued one-half to two hours, preferably one hour. Terminal fluorine-containing groups may thereby bonded to the hydroxyl or acyl functional ester oligomers and compounds. These oligomers and compounds can be optionally further functionalized with polymerizable groups described above by reacting any of the remaining hydroxyl or acyl groups in the resulting mixture with one or more of the reactive polymerizable group-containing compounds described above. Thus, the polymerizable compound(s) is (are) added to the reaction mixture, using the same conditions as with the previous additions.

Polymerizable group-containing compounds can be added and reacted with hydroxyl or acyl groups under the conditions described above in any of the steps described above. For example, as mentioned above, the polymerizable group-containing compound can be added as a mixture with the polyol. Alternatively, the polymerizable group-containing compound can be added (a) after reaction of the polyol with the polyacyl compound, (b) as a mixture with the monoalcohol(s), and (c) after reaction of the polyol and monofunctional compound with the polyacyl compound. When the polymerizable group-containing compound is a monoalcohol, it is preferably added as a mixture with the fluorine-containing monoalcohol. When the polymerizable group-containing compound is a diol, it is preferably added as a mixture with the polyol.

When the chemical composition of the present invention contains an ester oligomer having one or more carboxylic acid groups, solubility or dispersability of the composition in water can be further increased by forming a salt of the carboxylic acid group(s). Basic salt-forming compounds, such as tertiary amines, quaternary ammonium hydroxides, and inorganic bases, including, but not limited to, those selected from the group consisting of sodium hydroxide, potassium hydroxide, cesium hydroxide, lithium hydroxide, calcium hydroxide, magnesium hydroxide, zinc hydroxide, and barium hydroxide, may be used in a sufficient amount (i.e., in an amount to maintain a pH of greater than about 6). These basic salt-forming compounds preferably can be added in the water phase, but optionally in the preparation of the ester oligomers, to form salts with the incorporated, pendant and/or terminal carboxylic acid groups on the ester oligomer. Examples of useful amine salt-forming compounds include, but are not limited to, those selected from the group consisting of ammonia, trimethylamine, triethylamine, tripropylamine, triisopropylamine, tributylamine, triethanolamine, diethanolamine, methyldiethanolamine, morpholine, N-methylmorpholine, dimethylethanolamine, and mixtures thereof. Preferred salt forming compounds include those selected from the group consisting of ammonia, trimethylamine, dimethylethanolamine, methyldiethanolamine, triethylamine, tripropylamine, and triisopropylamine, since the chemical compositions prepared therefrom are not excessively hydrophilic upon coating and curing. Since certain salts formed by the reaction of salt forming compounds, such as potassium hydroxide in combination with a carboxylic acid group, could result in undesired reaction with acyl groups, it is preferred to add the salt forming compound in a water phase after all of the diols, alcohol, and silane compounds have been reacted with the acyl groups of the polyacyl compound.

If desired for particular applications, small amounts of one or more polymeric or non-polymeric chain extenders (for example, diamines) can be utilized, in addition to the above-described reactants, in preparing the fluorochemical composition.

The coating compositions of the present invention comprise aqueous suspensions, emulsions, or solutions, or organic solvent (or organic solvent/water) solutions, suspensions, or emulsions comprising the fluorochemical compositions of the present invention. When applied as coatings, the fluorochemical coating compositions impart oil- and water-repellency properties, and/or stain-release and stain-resistance characteristics to any of a wide variety of substrates.

The fluorochemical compositions of the present invention can be dissolved, suspended, or dispersed in a variety of solvents to form coating compositions suitable for use in coating the chemical compositions of the present invention onto a substrate. Aqueous suspensions, emulsions, or solutions are generally preferred and generally can contain a non-volatile solids content of about 0.1 to about 50 percent by weight (based on the total weight of the components). Depending upon the substrate to which the composition is being applied, water is the preferred solvent because it does not raise any environmental concerns and is accepted as safe and non-toxic.

Another embodiment of the present invention is an article comprised of a substrate having one or more surfaces and on the one or more surfaces of this substrate is a cured coating derived from the coating composition of the present invention. After application and curing of the coating composition, the article displays high water and hexadecane dynamic receding contact angles, oil- and water-repellency, and/or stain-release and stain-resistance properties.

The coating compositions of the present invention can be applied to a wide variety of substrates, including, but not limited to, fibrous substrates, leather substrates, and hard substrates. Illustrative examples of fibrous substrates include woven, knit, and nonwoven fabrics (e.g., of natural, synthetic, and natural/synthetic blends including, for example, cotton, linen, wool, silk, polyester, nylon, and blends of such fibers), laminates (e.g., nylon or polyester fabric bonded to expanded polytetrafluoroethylene (“PTFE”) such as are used in GORE™ membranes), textiles, carpets, and paper. Illustrative examples of hard substrates include, but are not limited to, glass, ceramic, masonry, concrete, natural stone, man-made stone, metals, wood, plastics, and painted surfaces. Substrates can have flat or curved surfaces and may be particulate and fibrous in nature, as well. Preferred substrates are fibrous or are capable of imbibing a liquid and are therefore porous. Such substrates are particularly subject to staining and soiling, but also benefit greatly from the fluorochemical compositions of the present invention because the coating composition can penetrate into the fibrous or porous substrate surface and spread over the internal surfaces of the substrate.

Representative examples of substrates that can be coated with the coating composition include lenses used in ophthalmic spectacles, sunglasses, optical instruments, illuminators, watch crystals, and the like; plastic window glazing; signs; decorative surfaces such as wallpaper and vinyl flooring; composite or laminated substrates such as FORMICA™ brand sheeting or laminated flooring (e.g., PERGO™ brand flooring); ceramic tile and fixtures (sinks, showers, toilets); natural and man-made stones; decorative and paving stones; cement and stone sidewalks and driveways; particles that comprise grout or the finished surface of applied grout; wood furniture surface (desktops, tabletops); cabinet surfaces; wood flooring, decking, and fencing; leather; paper; fiber glass fabric and other fiber-containing fabrics; textiles; carpeting; drapery material, upholstery, clothing, and the like.

Since coatings prepared from the coating compositions can render metal surfaces resistant to soils, the optical properties of metal surfaces like those on decorative metal strips and mirrors can be preserved longer. The coating compositions can make wood surfaces more resistant to food and beverage stains while helping to maintain a lustrous appearance. In addition, the coating compositions can be applied as a protective coating on aircraft wings, boat hulls, fishing line, medical surfaces, and siding, and can be used in food release, mold release, adhesive release applications, and the like. Decorative stones include, for example, marble, granite, limestone, slate, and the like.

Preferred substrates that can be coated with the coating composition of the present invention are fibrous substrates, such as nonwoven, knits, and woven fabrics, laminates, carpet, drapery material, upholstery, clothing and essentially any textile. To impart repellency and/or stain-resistance characteristics to a substrate having one or more surfaces, (a) the coating composition of the present invention is applied onto one or more surfaces of the substrate and (b) the coating composition is allowed to cure (i.e., dry) at ambient temperature or preferably at elevated temperatures. The use of elevated temperatures is particularly advantageous for curing fibrous substrates coated with the fluorochemical compositions of the present invention, since best repellency properties are then achieved. Elevated temperatures of about 50 to about 175° C. are preferred with about 100 to about 170° C. typically being more preferred.

The coating compositions can be applied to a treatable substrate by standard methods such as, for example, spraying, padding, dipping, roll coating, brushing, or exhaustion (optionally followed by the drying of the treated substrate to remove any remaining water or solvent). The treatable substrate can be in the form of molded or blown articles, sheets, fibers (as such or in aggregated form, for example, yarn, toe, web, or roving, or in the form of fabricated textiles such as carpets), woven and nonwoven fabrics, films, etc. When coating flat substrates of appropriate size, knife-coating or bar-coating may be used to ensure uniform coatings of the substrate. If desired, the fluorochemical composition can be co-applied with conventional fiber treating agents, for example, spin finishes or fiber lubricants. Such a topical treatment process can involve the use of the neat fluorochemical composition, without added solvent, and is thus preferred from an environmental perspective over the use of organic solvent solutions of the fluorochemical composition.

The coating compositions can be applied in an amount sufficient to achieve the desired repellency properties for a particular application. This amount can be determined empirically and can be adjusted as necessary or desired to achieve the repellency properties without compromising the properties of the treatable substrate.

The coating compositions can be applied to a substrate in any desired thickness. Coatings as thin as a few microns can offer excellent low surface energy, stain-resistance, and stain-release. However, thicker coatings (e.g., up to about 20 microns or more) can also be used. Thicker coatings can be obtained by applying to the substrate a single thicker layer of a coating composition that contains a relatively high concentration of the chemical composition of the present invention. Thicker coatings can also be obtained by applying successive layers to the substrate of a coating composition that contains a relatively low concentration of the fluorochemical composition of the present invention. The latter can be done by applying a layer of the coating composition to the substrate and then drying prior to application of a successive layer. Successive layers of the coating can then be applied to dried layers. This procedure can be repeated until the desired coating thickness is achieved.

To form a polymer melt blend by melt processing, the fluorochemical composition can be, for example, intimately mixed with pelletized or powdered polymer and then melt processed by known methods such as, for example, molding, melt blowing, melt spinning, or melt extrusion. The fluorochemical composition can be mixed directly with the polymer or it can be mixed with the polymer in the form of a “master batch” (concentrate) of the fluorochemical composition in the polymer. If desired, an organic solution of the fluorochemical composition can be mixed with powdered or pelletized polymer, followed by drying (to remove solvent) and then by melt processing. Alternatively, the fluorochemical composition can be injected into a molten polymer stream to form a blend immediately prior to, for example, extrusion into fibers or films or molding into articles.

After melt processing, an annealing step can be carried out to enhance the development of repellent characteristics. In addition to, or in lieu of, such an annealing step, the melt processed combination (for example, in the form of a film or a fiber) can also be embossed between two heated rolls, one or both of which can be patterned. An annealing step typically is conducted below the melt temperature of the polymer (for example, in the case of polyamide, at about 150 to about 220° C. for a period of about 30 seconds to about 5 minutes).

The fluorochemical composition can be added to thermoplastic or thermosetting polymer (or, alternatively, to other treatable substrate materials) in amounts sufficient to achieve the desired repellency properties for a particular application. The amounts can be determined empirically and can be adjusted as necessary or desired to achieve the repellency properties without compromising the properties of the polymer (or other treatable substrate material). Generally, the fluorochemical composition can be added in amounts ranging from about 0.1 to about 10 percent by weight (preferably, from about 0.5 to about 4 percent; more preferably, from about 0.75 to about 2.5 percent) based on the weight of polymer (or other treatable substrate material).

Shaped articles can be made from the water- and oil-repellent composition of the invention, and such constructions will find utility in any application where some level of repellency characteristics is required. For example, the composition of the invention can be used to prepare films and molded or blown articles, as well as fibers (for example, melt-blown or melt-spun fibers, including microfibers and sheath-core fibers) that can be used to make woven, knit, and nonwoven fabrics. Such films, molded or blown articles, fibers, and fabrics exhibit water and oil repellency (and soil resistance) characteristics under a variety of environmental conditions and can be used in a variety of applications.

For example, molded articles comprising the composition of the invention can be prepared by standard methods (for example, by high temperature injection molding) and are particularly useful as, for example, headlamp covers for automobiles, lenses (including eyeglass lenses), casings or circuit boards for electronic devices (for example, computers), screens for display devices, windows (for example, aircraft windows), and the like. Films comprising the composition of the invention can be made by any of the film making methods commonly employed in the art. Such films can be nonporous or porous (the latter including films that are mechanically perforated), with the presence and degree of porosity being selected according to the desired performance characteristics. The films can be used as, for example, photographic films, transparency films for use with overhead projectors, tape backings, substrates for coating, and the like.

Fibers comprising the composition of the invention can be used to make woven, knit, or nonwoven fabrics that can be used, for example, in making medical fabrics, medical and industrial apparel, fabrics for use in making clothing, home furnishings such as rugs or carpets, paper machine clothing, and filter media such as chemical process filters or respirators. Nonwoven webs or fabrics can be prepared by processes used in the manufacture of either melt-blown or spunbonded webs. For example, a process similar to that described by Wente in “Superfine Thermoplastic Fibers,” Indus. Eng'g Chem. 48, 1342 (1956) or by Wente et al. in “Manufacture of Superfine Organic Fibers,” Naval Research Laboratories Report No. 4364 (1954) can be used. Multi-layer constructions made from nonwoven fabrics enjoy wide industrial and commercial utility, for example, as medical fabrics. The makeup of the constituent layers of such multi-layer constructions can be varied according to the desired end-use characteristics, and the constructions can comprise two or more layers of melt-blown and spunbonded webs in many useful combinations such as those described in U.S. Pat. Nos. 5,145,727 (Potts et al.) and 5,149,576 (Potts et al.), the descriptions of which are incorporated herein by reference. In multi-layer constructions, the fluorochemical composition can be used alone in one or more layers or can be used in combination with other additive(s) in one or more layers. Alternatively, the fluorochemical composition and the other additive(s) can each be independently segregated in one or more layers. For example, in a spunbonded/melt-blown/spunbonded (“SMS”) three-layer construction, the other additive(s) (for example, antistats) can be used in one or both spunbonded layers, and the fluorochemical composition can be used in the melt-blown layer, to impart both antistatic and repellency characteristics to the overall construction.

The repellency-imparting, fluorochemical polymer composition can also find utility as an additive to coatings. Such coatings can be water- and oil-repellent, and scratch-resistant (as well as soil-resistant) and can be used in the photographic industry or as protective coatings for optical or magnetic recording media.

If desired, the water- and oil-repellent composition of the invention can further contain one or more additives, including those commonly used in the art, for example, dyes, pigments, antioxidants, ultraviolet stabilizers, flame retardants, surfactants, plasticizers, tackifiers, fillers, and mixtures thereof. In particular, performance enhancers (for example, polymers such as polybutylene) can be utilized to improve the repellency characteristics in, for example, melt additive polyolefin applications.

### EXAMPLES

Objects and advantages of this invention are further illustrated by the following examples, but the particular materials and amounts thereof recited in these examples, as well as other conditions and details, should not be construed to unduly limit this invention. In the examples, where weight percent or parts by weight are indicated, these are based on the weight of the entire composition unless indicated otherwise.

### Materials

ODDA—octadecanedioic acid, HO(O)C(CH₂)₁₆C(O)OH, from Cognis Corporation, Cincinnati, Ohio.
TDDA—tetradecanedioic acid, HO(O)C(CH₂)₁₂C(O)OH, from Cathay Industrial Biotech Ltd, Powell, Ohio.
FBSEE—C₄F₉SO₂N(C₂H₄OH)₂, can be prepared as described in Example 8 of U.S. Pat. No. 3,787,351 (Olson), except that an equimolar amount of C₄F₉SO₂NH₂ is substituted for C₈F₁₇SO₂NH₂; C₄F₉SO₂NH₂ can be prepared by reacting perfluorobutane sulfonyl fluoride (“PBSF”) with an equimolar amount of NH₃.
MeFBSE—C₄F₉SO₂N(CH₃)CH₂CH₂OH, having an equivalent weight of 357, can be made in two stages by reacting PBSF with methylamine and ethylenechlorohydrin, using a procedure as described in Example 1 of U.S. Pat. No. 2,803,656 (Ahlbrecht et al.).
C6 telomer—FLOWET™ EA 600 from Clariant Corporation.
C4 telomer—1H,1H,2H,2H-Nonafluoro-1-hexanol from TCI America, Portland, Oreg.
SA—Stearyl alcohol (1-octadecanol).
ETHOQUAD™ C12-dodecyl trimethyl ammonium chloride (75% in H₂O), from Akzo-Nobel.
ARMOCURE™ VGH-70 from Akzo-Nobel.
TERGITOL™ 15-S-30—C₁₂₋₁₆ alkyl polyoxyethylene (30 EO) surfactant, from Rohm & Haas
TERGITOL™ TMN-6—trimethyl nonane polyoxyethylene (6 EO) surfactant, from Rohm & Haas.
MIBK—methyl isobutyl ketone, 4-methyl-2-pentanone.

### Test Methods

Spray Rating (Spray)

The spray rating of a treated substrate is a value indicative of the dynamic repellency of the treated substrate to water that impinges on the treated substrate. The repellency was measured by Test Method 22-1996, published in the 2001 Technical Manual of the American Association of Textile Chemists and Colorists (AATCC), and was expressed in terms of a ‘spray rating’ of the tested substrate. The spray rating was obtained by spraying 250 ml water on the substrate from a height of 15 cm. The wetting pattern was visually rated using a 0 to 100 scale, where 0 means complete wetting and 100 means no wetting at all.

Oil Repellency (OR)

The oil repellency of a substrate was measured by the American Association of Textile Chemists and Colorists (AATCC) Standard Test Method No. 118-1983, which test was based on the resistance of a treated substrate to penetration by oils of varying surface tensions. Treated substrates resistant only to NUJOL® mineral oil (the least penetrating of the test oils) were given a rating of 1, whereas treated substrates resistant to heptane (the most penetrating of the test liquids) were given a rating of 8. Other intermediate values were determined by use of other pure oils or mixtures of oils, as shown in the following table.

Standard Test Liquids

| AATCC Oil Repellency | |
|---|---|
| Rating Number | Compositions |
| 1 | NUJOL ® |
| 2 | NUJOL ®/n-Hexadecane 65/35 |
| 3 | n-Hexadecane |
| 4 | n-Tetradecane |
| 5 | n-Dodecane |
| 6 | n-Decane |
| 7 | n-Octane |
| 8 | n-Heptane |

Bundesmann Test

In order to evaluate dynamic water repellency performance, the impregnating effect of rain on treated substrates was determined using the Bundesmann Test Method (DIN 53888). In this test, the treated substrates were subjected to a simulated rainfall, while the back of the substrate was being rubbed. The appearance of the upper exposed surface was checked visually after 1, 5, and 10 minutes and was given a rating between 1 (complete surface wetting) and 5 (no water remains on the surface). Generally, Bundesmann testing was only carried out if the initial spray rating for the samples was 95 or greater.

Laundering Procedure

The procedure set forth below was used to prepare treated substrate samples designated in the examples below as 5L (5 Launderings).

A 230 g sample of generally square, 400 cm² to about 900 cm² sheets of treated substrate was placed in a washing machine along with a ballast sample (1.9 kg of 8 oz fabric in the form of generally square, hemmed 8100 cm² sheets). A commercial detergent (SAPTON Brand Detergent, from Henkel, Germany, 46 g) was added and the washer was filled to high water level with hot water (40° C.+/−3° C.). The substrate and ballast load were washed five times using a 12-minute normal wash cycle followed by five rinse cycles and centrifuging. The samples were not dried between repeat cycles but were dried after the final cycle.

### Example 1

To a round-bottom reaction flask equipped with a stirrer, heater and a Dean-Stark trap was added ODDA (30 g, 0.095 moles), FBSEE (27.5 g, 0.071 moles), MeFBSE (17.01 g, 0.048 moles), toluene (100 g) and methanesulfonic acid (1 g). The resulting mixture was allowed to reflux for 15 hours at 115° C. When the desired amount of water (3 g) was collected, the temperature was reduced to 80° C. Then K₂CO₃ (2 to 3 g) was added and the mixture was stirred for an additional 30 minutes. FTIR analysis showed the absence of any hydroxyl peak. The mixture was then hot filtered and the solvent was removed by rotary evaporation.

### Examples 2-5, 7

Other polyester compositions were prepared and tested using procedures similar to that described above for Example 1, except having the components and ratios as indicated in Tables 1 and 2.

### Example 6

To a round-bottom reaction flask equipped with a stirrer, heater and a Dean-Stark trap was added ODDA (10.47 g, 0.033 moles), FBSEE (9.625 g, 0.025 moles), MeFBSE (2.975 g, 0.008 moles), C4MH spacer oligomer alcohol (20.37 g, 0.008 moles) (the same material as SPOL 2, prepared as described in US Patent Publication No. 2007/0004895 A1, published Jan. 4, 2007), toluene (150 g) and methanesulfonic acid (1 g). The resulting mixture was allowed to reflux for 15 hours at 115° C. When the desired amount of water (3 g) was collected, the temperature was reduced to 80° C. Then K₂CO₃ (2 to 3 g) was added and the mixture was stirred for an additional 30 minutes. FTIR analysis showed the absence of any hydroxyl peak. The mixture was then hot filtered and the solvent was removed by rotary evaporation.

### Comparative Example C1

The C14-polyester was made using the same molar ratios as in example 1 except the ODDA was replaced with TDDA.

### Emulsion Preparation and Application

C18 Polyester emulsification (Examples 1-7) as follows: To the resultant polymer solid (20 g) was added MIBK (50 g) and the mixture heated to 65° C. In a separate beaker ETHOQUAD C12 (0.53 g), TERGITOL 15-S-30 (0.6 g) and TMN-6 (1.2 g) were added to water (100 g). This mixture was stirred and heated to 65° C. The polymer in MIBK was slowly added to this stirring solution. The mixture was then sonicated for 4 minutes and the solvent was removed by rotary evaporation. The emulsions were applied on polyester and nylon test fabrics via pad-application at 0.6% SOF (solids on fiber), followed by 1.5 minutes cure at 160° C.

C18 Polyester emulsification (Example 8) as follows: The emulsion was prepared using the same procedure except the surfactants used were ARMOCURE™ VGH-70 (0.85 g) and TMN-6 (0.9 g) and a co-solvent dipropyleneglycol monomethyl ether (7.5 g).

C14 Polyester emulsification (Comparative Example C1) as follows: The emulsion was prepared using the same procedure except a co-solvent dipropyleneglycol monomethyl ether (7.5 g) was added to the water phase.

### Performance Results

Initial performance results were obtained after 24 hours conditioning at 70° F. and 60% RH. Performance durability was measured after 5 launderings of the initially treated fabrics at 40° C. as described above. Performance results are provided in Tables 1 (nylon fabric) and 2 (polyester fabric).

TABLE 1
Nylon Fabric

| | | | | | | | Post | |
|---|---|---|---|---|---|---|---|---|
| | | | | Bundesmann | | | Laundering | |
| | Nylon | Initial | | 1 | 5 | 10 | 5L | 5L |
| Example | (component molar ratio) | OR | Spray | Min | Min | Min | OR | Spray |
| 1 | ODDA/FBSEE/MEFBSE | 2 | 80 | NT | NT | NT | 0 | 0 |
| | (1/0.75/0.5) | | | | | | | |
| 2 | ODDA/FBSEE/MEFBSE | 2.5 | 95 | 2 | 1 | 1 | 0 | 0 |
| | (1/0.5/1) | | | | | | | |
| 3 | ODDA/FBSEE/MEFBSE | 0.5 | 80 | NT | NT | NT | 0 | 0 |
| | (1/0.9/0.2) | | | | | | | |
| 4 | ODDA/FBSEE/C6 Telomer | 4 | 90 | NT | NT | NT | 0 | 0 |
| | (1/0.75/0.5) | | | | | | | |
| 5 | ODDA/FBSEE/C4 Telomer | 2 | 80 | NT | NT | NT | 0 | 0 |
| | (1/0.75/0.5) | | | | | | | |
| 6 | ODDA/FBSEE/MEFBSE/C4M | 4.5 | 100 | 3 | 1 | 1 | 1 | 50 |
| | H spacer oligomer alcohol | | | | | | | |
| | (1/0.75/0.25/0.25) | | | | | | | |
| 7 | ODDA/FBSEE/MEFBSE/SA | 0.5 | 70 | NT | NT | NT | 0 | 0 |
| | (1/0.75/0.25/0.25) | | | | | | | |

TABLE 2
Polyester Fabric

| | | | | | | | Post | |
|---|---|---|---|---|---|---|---|---|
| | | | | Bundesmann | | | Laundering | |
| | Polyester | Initial | | 1 | 5 | 10 | 5L | 5L |
| Example | (component molar ratio) | OR | Spray | Min | Min | Min | OR | Spray |
| 1 | ODDA/FBSEE/MEFBSE | 3 | 95 | 1.5 | 1 | 1 | 0 | 50 |
| | (1/0.75/0.5) | | | | | | | |
| 2 | ODDA/FBSEE/MEFBSE | 5 | 100 | 3.5 | 3.5 | 2.5 | 0 | 50 |
| | (1/0.5/1) | | | | | | | |
| 3 | ODDA/FBSEE/MEFBSE | 2 | 80 | NT | NT | NT | 0 | 75 |
| | (1/0.9/0.2) | | | | | | | |
| 4 | ODDA/FBSEE/C6 Telomer | 4 | 90 | NT | NT | NT | 0 | 85 |
| | (1/0.75/0.5) | | | | | | | |
| 5 | ODDA/FBSEE/C4 Telomer | 4 | 85 | NT | NT | NT | 0 | 80 |
| | (1/0.75/0.5) | | | | | | | |
| 6 | ODDA/FBSEE/MEFBSE/C4M | 4 | 100 | 2 | 1 | 1 | 2 | 80 |
| | H spacer oligomer alcohol | | | | | | | |
| | (1/0.75/0.25/0.25) | | | | | | | |
| 7 | ODDA/FBSEE/MEFBSE/SA | 2 | 95 | 1.5 | 1 | 1 | 0 | 75 |
| | (1/0.75/0.25/0.25) | | | | | | | |

NT indicates that this test was not run.

The following performance comparison was made by pad application of the emulsions on 100% Cotton fabric. The solids of fabric (SOF) was targeted to be 0.9%. From the results it is evident that the C18-polyester (Example 8) shows higher dynamic water repellency than the comparative C14-polyester (Comparative Example C1).

| | Initial | | |
|---|---|---|---|
| Example | OR | WR | AATCC Spray |
| 8 | 5 | 6 | 95 |
| C1 | 5 | 6 | 50 |

### Examples 9 and 10

Examples 9 and 10 illustrate use of the invention on laminate substrates. A 2.5% SIB loading of a C18 embodiment of the invention was applied to the indicated laminate.

The oligomer composition was made as follows. To a round-bottom reaction flask equipped with a stirrer, heater, and a Dean-Stark trap was added ODDA (30 g, 0.095 moles), FBSEE (27.5 g, 0.071 moles), MeFBSE (17.01 g, 0.048 moles), heptane (100 g) and methanesulfonic acid (1 g). The resulting mixture was allowed to reflux for 5 hours at 100° C. When the desired amount of water (3 g) was collected, the temperature was reduced to 80° C. Then triethylamine (1.10 g) was added and the mixture was stirred for an additional 30 minutes. The heptane was then removed by distillation. A sample (40 grams) of the remaining polyester solid was dissolved in 80 grams methyl isobutyl ketone (MIBK) in a three-necked 500 mL round-bottomed flask. The mixture was heated to 65° C. Separately, to 200 grams deionized water was added 1.71 grams of VGH-70 (70% solids), 2.1 g of TERGITOL™ TMN-6 (90% solids), and 15 g dipropylene glycol monomethyl ether. The water mixture was heated to 65° C., then slowly added to the polyester mixture with rapid agitation. After mixing for 15 minutes, the contents of the flask were passed through a homogenizer two times at a pressure of 2500 psig. The resulting emulsion was stripped of MIBK by vacuum distillation at 35° C. The resulting emulsion was 18.5% solids.

In Example 9, the substrate was a two layer laminate of a 86 g/m² woven nylon fabric bonded to a 35 g/m² expanded PTFE (porosity of 80%) membrane partially impregnated with a monolithic urethane coating, obtained from W. L. Gore and Associates, Inc., Elkton, Md.

In Example 10, the substrate was a two layer laminate of a 78 g/m² woven polyester fabric bonded to a 35 g/m² expanded PTFE (porosity of 80%) membrane partially impregnated with a monolithic urethane coating, obtained from W. L. Gore and Associates, Inc., Elkton, Md.

The following performance was obtained.

| | Ratings | | | | | | | | | |
|---|---|---|---|---|---|---|---|---|---|---|
| | | | Bundesman | | | | | | | |
| Ex. | Initial | | (minutes) | | | | 1L | | 5L | |
| No. | O/R | Spray | 1 | 5 | 10 | Total | O/R | Spray | O/R | Spray |
| 9 | 3 | 100 | 2.5 | 1.5 | 1.5 | 5.5 | 2 | 75 | 0 | 60 |
| 10 | 2 | 70 | 1 | 1 | 1 | 3 | 2 | 60 | 0 | 0 |

Various modifications and alterations of this invention will become apparent to those skilled in the art without departing from the scope and spirit of this invention.

What is claimed is:

1. A fluorochemical ester composition comprising one or more oligomers wherein each oligomer comprises (i) at least one long chain fluorine-containing repeatable unit and (ii) at least one fluorine-containing terminal group, and wherein said compounds or oligomers comprise the condensation reaction product of:
(a) one or more fluorinated polyols;
(b) one or more polyacyl compounds containing 17 or more carbon atoms; and
(c) one or more monofunctional fluorine-containing compounds comprising a functional group that is reactive with the hydroxyl group of said polyol (a) or with the acyl group of the polyacyl compounds (b).

2. The oligomers of claim 1 further comprising the reaction product of one or more polymerizable compounds comprising one or more polymerizable groups and at least one electrophilic or nucleophilic moiety, said polymerizable groups independently pendant from the repeating unit, or terminal portion.

3. The polymerizable oligomers of claim 2, wherein said polymerizable groups are selected from the group consisting of acrylate, methacrylate, vinyl allyl, and glycidyl groups.

4. The oligomers of claim 1 of the formula (I):
R^{f}Q[OR²]ₒ[OC(O)R¹C(O)OR²O]ₙ[C(O)R¹C(O)]ₘT (I)
wherein:
o is a number from 0 to 1 inclusive;
n is a number from 1 to 10 inclusive;
m is number from 0 to 1 inclusive;
R^{f} is a perfluoroalkyl group having 1 to 12 carbon atoms, or a perfluoroheteroalkyl group having 3 to about 50 carbon atoms with all perfluorocarbon chains present having 1 to 6;
Q is a divalent linking group;
R¹ is the same or different polyvalent organic groups that is a residue of a polyacyl compound, that is a straight or branched or unsaturated chain alkylene, group of 15 to 20 carbon atoms;
R² is the same or different divalent organic group that is a residue of the polyol, at least a portion of which are substituted with or contain one or more perfluoroalkyl groups, perfluoroheteroalkyl groups, perfluoroheteroalkylene groups, or mixtures thereof; and
T is R^{f}Q or a non-fluorine containing monofunctional compound capable of reacting with a polyacyl compound or a polyol.

5. The oligomer of claim 4, wherein Q is selected from the following structures, wherein each k is independently an integer from 0 to 20, R^{1′} is hydrogen, phenyl, or alkyl of 1 to 4 carbon atoms, and R^{2′} is alkyl of 1 to 20 carbon atoms:

| | |
|---|---|
| —SO₂NR^{1′}(CH₂)ₖO(O)C— | —CONR^{1′}(CH₂)ₖO(O)C— |
| —(CH₂)ₖO(O)C— | —CH₂CH(OR^{2′})CH₂O(O)C— |
| —(CH₂)ₖC(O)O— | —(CH₂)ₖSC(O)— |
| —(CH₂)ₖO(CH₂)ₖO(O)C— | —(CH₂)ₖS(CH₂)ₖO(O)C— |
| —(CH₂)ₖSO₂(CH₂)ₖO(O)C— | —(CH₂)ₖS(CH₂)ₖOC(O)— |
| —(CH₂)ₖSO₂NR^{1′}(CH₂)ₖO(O)C— | —(CH₂)ₖSO₂— |
| —SO₂NR^{1′}(CH₂)ₖO— | —SO₂NR^{1′}(CH₂)ₖ— |
| —(CH₂)ₖO(CH₂)ₖC(O)O— | —(CH₂)ₖSO₂NR^{1′}(CH₂)ₖC(O)O— |
| —(CH₂)ₖSO₂(CH₂)ₖC(O)O— | —CONR^{1′}(CH₂)ₖC(O)O— |
| —(CH₂)ₖS(CH₂)ₖC(O)O— | —CH₂CH(OR^{2′})CH₂C(O)O— |
| —SO₂NR^{1′}(CH₂)ₖC(O)O— | —(CH₂)ₖO— |
| —CₖH₂ₖ—OC(O)NH— | —CₖH₂ₖ—NR^{1′}C(O)NH—, |
| —OC(O)NR′(CH₂)ₖ— | —(CH₂)ₖNR^{1′}— and |
| —(CH₂)ₖNR^{1′}C(O)O— | |

6. The oligomers of claim 1 of the formula (III):
R^{f}Q[C(O)R¹C(O)OR²O]ₙ[C(O)R¹C(O)]ₘQR^{f} (III)
wherein:
n is a number from 1 to 10 inclusive;
m is 1;
R^{f} is a perfluoroalkyl group having 1 to 12 carbon atoms, or a perfluoroheteroalkyl group having 3 to 50 carbon atoms with all perfluorocarbon chains present having 1 to 6;
Q is a divalent linking group;
R¹ is a straight chain alkylene of 15 to 22 carbon atoms;
R² is a polyvalent organic group which is a residue of the polyol, that is a straight or branched chain alkylene, cycloalkylene, arylene or heteroalkylene group of 1 to 14 carbon atoms, or an arylene group of 6 to 12 carbon atoms wherein at least a portion of R² groups comprise one perfluoroalkyl group, perfluoroheteroalkyl group, perfluoroheteroalkylene group, or mixtures thereof.

7. The composition of claim 1 wherein the oligomer comprises the condensation reaction product of one or more fluorinated polyols, one or more non-fluorinated polyols, one or more polyacyl compound, and one or more monofunctional fluorine-containing compounds.

8. The composition of claim 1 wherein the oligomer comprises the condensation reaction product of one or more fluorinated polyols, an excess amount (relative to the polyol) of one or more linear alkylene diacyl compounds, and sufficient fluorinated monoalcohols to react with the terminal acyl groups

9. The fluorochemical composition of claim 1 wherein the fluorine containing group of said polyol is a perfluoroalkyl group of 6 or fewer carbon atoms.

10. The fluorochemical composition of claim 1 wherein the fluorine containing group of said polyol is a perfluoroalkyl group of 3 to 5 carbon atoms.

11. The fluorochemical composition of claim 1 wherein the wherein the fluorine containing group of said polyol is a perfluoroalkyl group of is perfluorobutyl.

12. The fluorochemical composition of claim 1 wherein the monofunctional fluorine-containing compound is a compound of the following formula (II):
R^{f}Q′ (II)
wherein:
R^{f} is selected from the group consisting of perfluoroalkyl group having 1 to 12 carbon atoms, and perfluoroheteroalkyl group having 3 to 50 carbon atoms with all perfluorocarbon chains present having 6 or fewer carbon atoms;
Q′ is a functional group that is reactive with the terminal acyl group of the polyacyl group or terminal hydroxy group of the polyol.

13. The monofunctional fluorine-containing compound of claim 12 wherein Q′ is selected from hydroxyl, secondary amino, oxazolinyl, oxazolonyl, acetyl, acetonyl, carboxyl, isocyanato, epoxy, aziridinyl, thio, ester and acyl halide groups.

14. The fluorochemical composition of claim 1 wherein said fluorochemical oligomer further comprises the reaction product of one or more non-fluorinated polyols.

15. A coating composition comprising a mixture comprising:
(a) a solvent and
(b) the fluorochemical composition of claim 1.

16. The coating composition of claim 15 wherein said mixture comprises an aqueous solution, dispersion or suspension.

17. An article comprising a substrate having a coating of the fluorochemical composition of claim 1 on one or more surfaces of said substrate.

18. The article of claim 17 wherein the fluorochemical composition further comprises one or more polymerizable groups.

19. The article of claim 17 wherein the substrate is selected from the group consisting of hard substrates and fibrous substrates.

20. The article of claim 17 wherein the substrate is a laminate.

21. A method of imparting repellency to a substrate comprising the steps of:
applying the coating composition of claim 17 onto one or more surfaces of said substrate; and
curing the coating composition at ambient or elevated temperature.
